(19) United States
(12) Patent Application Publication
(10) Pub. No.: US 2025/0026693 A1
(43) Pub. Date: Jan. 23, 2025

(54) METHOD FOR PREPARING A FERTILISER COMPOSITION

(71) Applicant: CCM TECHNOLOGIES LIMITED, Swindon (GB)

(72) Inventor: Peter HAMMOND, Swindon (GB)

(21) Appl. No.: 18/714,330

(22) PCT Filed: Nov. 29, 2022
(86) PCT No.: PCT/GB2022/053014

§ 371 Date: May 29, 2024

(30) Foreign Application Priority Data
Nov. 29, 2021 (GB) 2117190.5

(51) Int. Cl. C05C 5/00; A01G 24/20; C05C 5/04; C05C 9/00; C05D 9/00; C05F 17/00; C05G 5/10

(52) U.S. Cl. CPC C05C 5/005; A01G 24/20; C05C 5/04; C05C 9/005; C05D 9/00; C05F 17/00; C05G 5/10

(57) ABSTRACT

A method of preparing a fertiliser composition, the method comprising the steps of: (i) providing a digestate material; (ii) contacting the digestate material with a composition comprising carbon dioxide; (iii) contacting the material obtained in step (ii) with a source of nitrate and/or sulfate; and (iv) admixing the material obtained in step (iii) with urea.

The present invention relates to fertiliser compositions, in particular fertiliser compositions comprising urea.

Urea is commonly included in fertiliser compositions as a source of nitrogen. However the presence of urease enzymes in soil can quickly cause degradation of the urea present in these compositions. This causes a number of problems. As well as the reduced availability of nutrients to plants, the degradation of urea by urease produces ammonia and carbon dioxide which may be released into the atmosphere. The release of such gases is highly undesirable. Aqueous ammonia may also run off the land into nearby rivers and streams.

Globally, around 43% of atmospheric ammonia is attributed to the volatilisation from soils due to over application of chemical fertilisers in agriculture. The emissions of nitrogen based gases from agricultural chemical fertiliser can also include nitrous oxides. Ammonia can negatively impact the environment, increasing soil pH, cause damage to human health, cause increases in eutrophication and biodiversity loss. Nitrous oxides have a high global warming potential, of 300. This means that nitrous oxides warm the earth 300 times more than carbon dioxide.

Due to high volatilisation of fertiliser compositions containing urea and the associated release of ammonia, governments are considering introducing legalisation to mandate the inclusion of a urease inhibitor in fertiliser compositions comprising urea. However introducing a urease inhibitor into soil can lead to other deleterious effects as the urease present in soil provides a number of useful functions.

The loss of nitrogen containing compounds through leaching can also cause significant problems. The presence of nitrogen salts in waterways can cause eutrophication and a reduction in biodiversity. The reduction in nutrient levels in the soil due to leaching can cause crop deficiencies leading to farmers applying move fertiliser and exacerbating the problem.

It is an aim of the present invention to provide a fertiliser composition comprising urea which is not readily lost due to volatilisation and/or run off.

According to a first aspect of the invention there is provided a method of preparing a fertiliser composition, the method comprising the steps of:
(i) providing a digestate material;
(ii) contacting the digestate material with a composition comprising carbon dioxide;
(iii) contacting the material obtained in step (ii) with a source of nitrate and/or sulfate; and
(iv) admixing the material obtained in step (iii) with urea.

Step (i) of the present invention involves providing a digestate material.

The digestate may comprise an anaerobic digestate, an aerobic digestate or a mixture thereof.

Preferably the digestate material is a material obtained by anaerobic digestion of organic matter. Preferably the digestate material is obtained by the anaerobic digestion of a waste product.

An anaerobic digestate is the material left following anaerobic digestion of a biodegradable feedstock. In some preferred embodiments the digestate is a methanogenic digestate.

The digestate material may be obtained from the anaerobic digestion of any suitable material, for example grass silage, chicken litter, cattle slurry, wholecrop rye, energy beet, potato, wheat straw, chicken manure, cattle manure with straw, pig manure, food waste, food processing waste and sewage sludge.

Suitably the digestate material is obtained from the anaerobic digestion of food waste or from the anaerobic digestion of farm slurry, for example pig or cow manure or chicken waste.

Preferably the digestate material comprises a digestate cake obtained following anaerobic digestion. This digestate cake can be separated from the digestate liquor and typically comprises 20 to 30% by weight dry matter.

In some embodiments a digestate cake may be dried to reduce the water content prior to use.

Step (ii) involves contracting the digestate material with a composition comprising carbon dioxide.

The composition comprising carbon dioxide may consist essentially of carbon dioxide and/or it may comprise a mixture of carbon dioxide and one or more further components.

In some embodiments the carbon dioxide may be provided in solid form.

Preferably step (ii) involves contacting the digestate material with a composition comprising carbon dioxide wherein the composition is in gaseous form. The composition may comprise neat carbon dioxide gas and/or it may comprise a gaseous mixture of carbon dioxide and one or more further gases.

Preferably the composition used in step (ii) comprises at least 5 vol % carbon dioxide, preferably at least 10 vol %, preferably at least 20 vol %.

The composition preferably comprises at least 50 vol % carbon dioxide, suitably at least 60 vol %, for example at least 80 vol %, at least 90 vol % or at least 95 vol %.

In some embodiments step (ii) involves contacting the digestate material with neat carbon dioxide gas.

In some embodiments step (ii) involves contacting the digestate material with the exhaust gas from combustion, for example the combustion of fossil fuel. For example step (ii) may involve contacting the flue gases from a power station with the digestate materal.

The use of flue gases to provide the carbon dioxide is highly beneficial because the SOₓ and NOₓ gases present in the flue gas mixture may also dissolve in the composition and provide additional nutrients in the final fertiliser composition in the form of sulphates and nitrates.

In some especially preferred embodiments the source of carbon dioxide is biogas and step (ii) involves contacting the digestate material with biogas.

Biogas describes the mixture of methane and carbon dioxide that is obtained during anaerobic digestion. It may also comprise other gases in minor amounts, for example hydrogen sulphide. The exact levels of carbon dioxide and methane present in biogas depends on the mixture that has been digested and the digestion conditions. Typically biogas comprises from 20 to 80 vol % carbon dioxide, for example 30 to 70 vol %. In some embodiments biogas comprises from 40 to 45 vol % carbon dioxide and 55 to 60 vol % methane.

In some embodiments the composition comprising carbon dioxide may comprise the exhaust gases from the combustion of biogas, or of methane recovered from biogas.

One particular advantage of the method of the present invention is that it can use both the digestate and the biogas produced during anaerobic digestion.

In some preferred embodiments in which the composition comprising carbon dioxide comprises the exhaust gas from the combustion of fossil fuel and/or biogas, the hot gas mixture may be first contacted with a heat exchanger to capture heat energy from said gases.

During step (ii) the carbon dioxide which is contacted with the digestate material is suitably retained within and forms part of a new composition. Thus step (ii) suitably removes carbon dioxide from the source of carbon dioxide that it is contacted with. Thus in some embodiments step (ii) may involve capturing carbon dioxide from an exhaust gas produced by combustion, for example of fossil fuel.

In some preferred embodiments step (ii) involves removing carbon dioxide from biogas. The resulting biogas thus has an increased relative concentration of methane and will therefore burn more easily. Thus the present invention may provide a method of enriching biogas.

Preferably the weight ratio of carbon dioxide to digestate material used in step (ii) is from 1:100 to 1:1, preferably from 1:50 to 1.5, for example about 1:10.

Step (ii) may involve an exothermic reaction. Heat from this reaction may be captured. It may suitably be reused in the process.

In preferred embodiments the method of the present invention does not include any heating steps.

Step (iii) involves contacting the material obtained in step (ii) with source of nitrate and/or a source of sulfate.

In some embodiments step (iii) may further involve contacting the material obtained in step (ii) with a source of potassium.

In some embodiments step (iii) may further involve contacting the material obtained in step (ii) with a source of phosphorus.

In some embodiments step (iii) may involve contacting the material obtained in step (ii) with a source of nitrate and/or a source of sulfate; a source of potassium and a source of phosphorus.

In some embodiments the method of the present invention involves contacting the material obtained in step (ii) with a source of nitrate ion.

The source of nitrate ion may be nitric acid or a water soluble nitrate salt.

Preferably the source of nitrate ion is a water soluble nitrate salt. Suitable nitrate salts include alkali metal, alkaline earth metal and ammonium salts.

A preferred source of nitrate ions is calcium nitrate.

The source of nitrate ion may be provided as a solid or a liquid.

In some embodiments the source of nitrate may comprise a waste material.

For example, in some embodiments the source of nitrate may comprise a waste stream from the ODDA/nitrophosphate process. Such a waste stream will also comprise phosphate residues thus providing a source of phosphorous in the fertiliser composition obtained by the method of the invention.

In some embodiments the source of nitrate may comprise waste from the scrubbing of combustion exhausts with nitric acid.

In some embodiments the source of nitrate ion is nitric acid.

In some embodiments the source of nitrate ion is calcium nitrate provided by the reaction of wood ash and nitric acid.

Step (iii) may involve contacting the composition provided in step (ii) with a source of sulfate ions.

Suitably the source of sulfate ion is a metal or ammonium salt. Preferably the source of sulfate ion is a metal salt, preferably an alkali metal or alkaline earth metal salt.

In some embodiments the sulfate ion is provided a water soluble form.

In some preferred embodiments the sulfate is provided as a calcium salt.

The source of sulfate may be provided as a solid or a liquid. It may suitably be provided as a slurry.

In some embodiments the source of sulfate ion is provided as an aqueous solution or suspension. In some preferred embodiments the sulfate is added in solid form, suitably as a powder.

The source of sulfate ion may be a natural material or a waste material from an industrial farming process.

For example, in some embodiments the source of sulfate ion comprises gypsum.

Gypsum (calcium sulfate dihydrate, CaSO₄·2H₂O) is the main product of desulfurization system for the removal of SOₓ at fossil-fuel power plants.

In some embodiments the source of sulfate ion comprises a waste stream from an industrial process. For example the source of sulfate ion may comprise the residue from an industrial scrubbing process, for example used limestone scrubbers from a coal fired power station. In some preferred embodiments the source of sulfate ion is the waste stream from the desulfurization system for the removal of SOₓ at fossil-fuel power plants.

Preferably the source of sulfate is solid powdered gypsum.

Suitable sources of calcium include calcium nitrate and calcium sulphate. In some embodiments step (iii) may involve contacting the material obtained in step (ii) with calcium nitrate and calcium sulfate.

Suitably the source of sulfate ions and/or source of nitrate ions is added in an amount of from 0.011 to 100 wt %, preferably 0.1 to 50 wt %, preferably 0.5 to 20 wt %, suitably 1 to 10 wt %, for example 1 to 5 wt %, based on the weight of the digestate material provided in step (i).

The above amounts apply to the total amount of sulfate and nitrate ions when both are used.

In some embodiments step (iii) of the method of the present invention involves contacting the material obtained in step (ii) with a source of potassium.

Suitable sources of potassium include inorganic potassium salts, for example potassium chloride and potassium sulfate; and potassium oxide.

In some embodiments step (iii) of the method of the present invention further involves adding a source of phosphorus.

Phosphorus may be provided in an anaerobic digestate liquor. In particular anaerobic digestates from the digestion of human and/or animal waste are rich in phosphorous.

A waste stream from the ODDA/nitrophosphate process may be used to provide a source of nitrate and a source of phosphorus.

Further or alternative sources of phosphorus and/or potassium may be also added.

In some embodiments ash from an organic source may provide a source of potassium and optionally a source of phosphorus.

Thus in some embodiments step (iii) may involve contacting the material obtained in step (ii) with ash from an organic source.

By ash from an organic source we mean to refer to the ash obtained from the incineration, pyrolysis or gasification of an organic material. This may be provided by the combustion of any organic material, for example the incinerated, pyrolysed or gasified waste from a water treatment plant or the ash obtained from the incineration, pyrolysis or gasification of a digestate cake obtained from an anaerobic digestion plant.

Organic ashes suitable for use in the present invention include high carbon materials commonly known as biochar.

A preferred ash from an organic source is wood ash.

By wood ash we mean to refer to the residue remaining following the incineration, gasification or pyrolysis of wood. Any suitable source of wood ash may be used. One preferred source is the incinerated waste from wood fired power stations. The ash produced in wood fired power stations typically contains light levels of compounds which can provide nutrients to plants, such as sources of phosphorus, calcium, potassium and magnesium. Preferably the wood ash comprises metal oxides, for example calcium oxide, magnesium oxide and potassium oxide as well as carbonates, for example calcium carbonate. Phosphorus oxides and phosphate compounds may also be present.

Other preferred sources of wood ash include waste from a gasification plant or waste from a pyrolysis plant.

Preferably the source of potassium is added in an amount to provide 1 to 20 wt, preferably 2 to 10 wt % potassium in the final product.

Preferably the source of phosphorus is added in an amount to provide 1 to 20 wt %, preferably 2 to 10 wt % phosphorus in the final product.

Step (iv) involves admixing the material obtained in step (iii) with urea.

Step (iv) may involve contacting the material obtained in step (iii) with neat urea or with a composition comprising urea and one or more further components. For example in some embodiments step (iv) may involve contacting the material obtained in step (iii) with a solution of urea. In some embodiments step (iv) may involve contacting the material obtained in step (iii) with a waste material comprising urea.

Preferably step (iv) involves contacting the material with neat urea in solid form.

Preferably the urea is added in an amount of from 1 to 50 wt %, preferably 2 to 40 wt %, more preferably 3 to 30 wt %, suitably 5 to 20 wt %, based on the weight of the material obtained following step (iii).

In some embodiments the method of the present invention may involve the addition of one or more further components. Preferably the one or more further components provides a further source of one or more nutrients.

The one or more further components may be added before, after or during step (i); and/or before, during or after step (ii); and/or before, during or after step (iii) and/or before, during or after step (iv).

In preferred embodiments the one or more further components comprises a waste material.

The material obtained following steps (i) to (iv) of the method of the present invention can be used directly as a fertiliser composition and is highly nutritious. It contains many of the minerals that plants need for growth. It also provides a useful means of storing carbon dioxide.

This product can be used directly as a fertiliser or can be further processed to provide an easier to handle form.

In some embodiments the method of the present invention involves a step (v) of further processing the material obtained in step (iv). The further processing step (v) may involve drying, pulverising and/or granulating the material. Such processing methods will be known to the person skilled in the art.

In some embodiments step (v) involves dying the material obtained in step (iv).

Preferably step (v) involves pelletising the material obtained after step (iv). It has been advantageously found that this material is easily pelletised. The pellets do not clump together and spread as readily as leading commercially available fertiliser compositions of the prior art.

According to a second aspect of the invention there is provided a fertiliser composition obtained by the method of the first aspect.

Preferred features of the second aspect are as defined in relation to the first aspect.

Further preferred features of the first and second aspects of the present invention will now be described.

The fertiliser composition provided by the present invention suitably comprises at least 3 wt % of nitrogen, suitably at least 5 wt %, preferably at least 8 wt %. Suitably the fertiliser composition provided by the present invention comprises up to 32 wt % nitrogen, preferably up to 30 wt %, for example up to 20 wt % or up to 18 wt %.

In some preferred embodiments the composition comprises from 10 to 15 wt % nitrogen.

In some embodiments in which a source of sulfate ions is added in step (ii) the composition comprises 2 to 10 wt % sulfur.

The composition of the present invention preferably comprises one or more further plant nutrients, for example potassium or phosphate.

In some embodiments the composition comprises 1 to 15 wt % potassium, for example 3 to 10 wt %.

In some embodiments the composition comprises 1 to 15 wt % phosphate, for example 3 to 10 wt %.

The present invention offers significant advantages in that it uses multiple waste products to generate a useful fertiliser composition. For example the present invention can make use of an anaerobic digestate which is generally considered unsuitable for direct use as a fertiliser as it is in difficult to handle form. By admixing with other components, an easier to handle solid fertiliser composition having an improved nutrient composition is provided.

A particular advantage of the present invention is that urea is not readily degraded by the fertiliser composition.

Preferably less than 50 wt % of urea present in the fertiliser composition is lost due to degradation, volatilisation and/or run off within 7 days of application to soil.

Preferably less than 30 wt % of urea present in the fertiliser composition is lost due to degradation, volatilisation and/or run off within 7 days of application to soil.

Preferably less than 50 wt % of urea present in the fertiliser composition is lost due to degradation, volatilisation and/or run off within 14 days of application to soil.

Preferably less than 30 wt % of urea present in the fertiliser composition is lost due to degradation, volatilisation and/or run off within 14 days of application to soil.

The present inventors have tested products of the present invention and have found them to be as effective as a leading major fertiliser composition, whilst releasing much lower levels of ammonia into the environment.

According to a third aspect of the present invention there is provided a method of increasing the nutrient content of a plant growing medium, the method comprising:
(i) providing a digestate material;
(ii) contacting the digestate material with a composition comprising carbon dioxide;
(iii) contacting the material obtained in step (ii) with a source of nitrate and/or sulfate;
(iv) admixing the material obtained in step (iii) with urea;
(v) optionally adding one or more further components and/or further processing the material obtained in step (iv); and
(vi) admixing the mixture obtained after step (iv) with the plant growing medium.

Steps (i) to (v) of the method of the third aspect are preferred as defined in relation to the first aspect and preferred features of the first aspect apply to the third aspect.

The invention may be used to increase the nutrient content of any suitably plant growing medium.

Suitable plant growing media will be known to the person skilled in the art and include for example soil, compost, clay, coco, and peat.

Preferably the plant growing medium is soil.

Preferably in step (vi) the mixture obtained after steps (iv) and optionally (v) is admixed with the plant growing medium in an amount of from 1 to 50 wt %, preferably 5 to 20 wt %.

As previously described herein the present invention offers significant advantages. In particular the combination of components used in the invention provides a solid fertiliser composition which is easy to handle, easy to pelletise and does not readily release ammonia.

The present inventors have also found that the fertiliser compositions of the present invention are effective even when applied at reduced levels of nitrogen.

Advantageously, in addition to nitrogen, the compositions of the present invention deliver other nutrients to the soil that are not present in traditional chemical fertilisers, and improve the soil condition.

The invention will now be further described with reference to the following non-limiting examples.

### EXAMPLE 1

A fertiliser composition of the present invention was prepared as follows:

Neat carbon dioxide gas (recovered from a brewing process) was bubbled through an anaerobic digestate cake for 20 minutes. Calcium nitrate (3% by weight based on the digestate) was then added, followed by urea (20% by weight based on the digestate).

The resultant mixture was mixed using a ribbon blender and then pelletised using a standard pellet mill to provide 6 mm pellets.

### EXAMPLE 2

Three containers were filled with 50 ml of sand and 50 ml of soil which was well mixed. The pellets of example 1 were added to the first container (A), ground up pellets were added to the second container (B) and a commercially available urea based fertiliser was added to the third container (C). The amount of fertiliser added in each case was selected to ensure the same amount of nitrogen was provided.

10 ml of water was added immediately prior to closing the containers. The lids of the containers were connected to Draeger simultaneous testing adapters selected to measure ammonia emissions in ppm by weight.

The containers were allowed to stand until no further emissions were noted with reading taken each day.

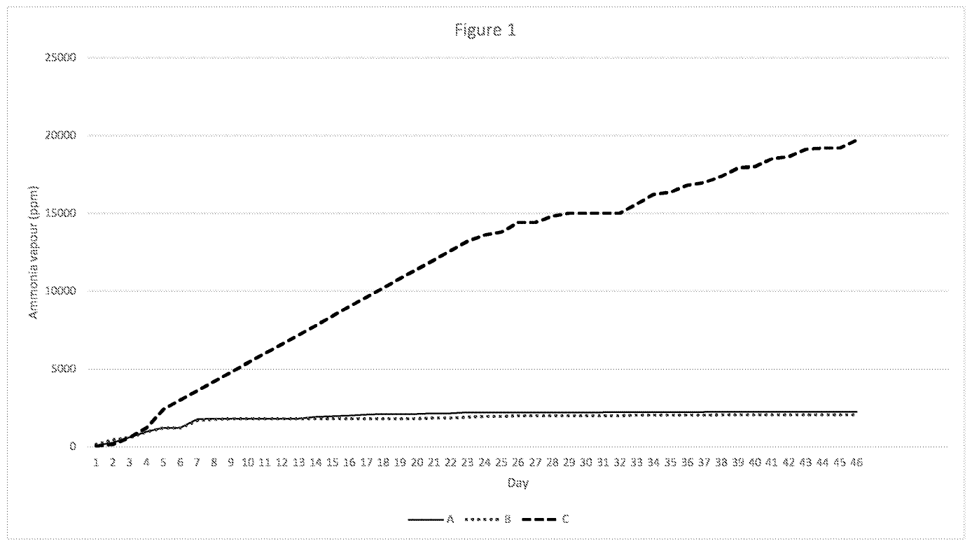

The results are shown in FIG. 1.

### EXAMPLE 3

An experiment was carried out to measure the teaching from the pellets of the example 1 with a convention ammonium nitrate fertiliser.

Chromatography columns were filled with 4 inches of sand and washed thoroughly to remove any impurities. A mass of each material was taken to include equal amounts (0.349 g) total nitrogen. Each day the column was filled with 100 ml of water and left sealed overnight. The next day the columns were drained and analysed to determine the concentration of nitrate, nitrite, ammonia, ammonium, and phosphate, using a palintest photometer.

The sum of these nitrogen components for this experiment is considered the total nitrogen. This nitrogen content has been converted to a % of the total nitrogen given off by an individual sample.

The time taken for 90% of the total nitrogen to be lost from the sample was as follows:
ammonium nitrate—9 days
example 1—4 days

### EXAMPLE 4

The further fertiliser compositions of the present invention were prepared using a method analogous to the method of example 1.

These compositions (X, Y and Z contained different amounts of nitrogen by weight).

The efficacy of the fertiliser compositions X, Y and Z was compared with that of a conventional ammonium nitrate and urea based fertilisers.

An independent field trial was carried out to determine the crop yield of winter wheat when using the different fertilisers.

In the trial two portions of fertiliser were added on 25 February and 23 March. The wheat was harvested on 9 August.

The results are shown in table 1:

| | | N | N | Total | |
|---|---|---|---|---|---|
| | | application | application | Nitrogen | Crop |
| | Wt % | rate 25 Feb | rate 25 Feb | applied | yield |
| Composition | nitrogen | (kgN/ha) | (kgN/ha) | (Kg/ha) | (T/ha) |
| Untreated | 0 | 0 | 0 | 0 | 7.97 |
| control | | | | | |
| Conventional | 34.5 | 112.5 | 56 | 56 | 10.12 |
| ammonium | | | | | |
| nitrate | | | | | |
| fertiliser | | | | | |
| Conventional | 46 | 112.5 | 56 | 56 | 9.90 |
| urea based | | | | | |
| fertiliser | | | | | |
| X | 5 | 112.5 | 56 | 56 | 9.80 |
| Y | 10 | 150 | 75 | 75 | 9.53 |
| Z | 15 | 150 | 75 | 75 | 9.87 |
| Conventional | 34.5 | 165 | 82.5 | 82.5 | 11.89 |
| ammonium | | | | | |
| nitrate | | | | | |
| fertiliser | | | | | |
| Conventional | 46 | 165 | 82.5 | 82.5 | 10.29 |
| urea based | | | | | |
| fertiliser | | | | | |
| X | 5 | 165 | 82.5 | 82.5 | 9.83 |
| Y | 10 | 220 | 110 | 110 | 10.00 |
| Z | 15 | 220 | 110 | 110 | 10.13 |

1. A method of preparing a fertiliser composition, the method comprising the steps of:
(i) providing a digestate material;
(ii) contacting the digestate material with a composition comprising carbon dioxide;
(iii) contacting the material obtained in step (ii) with a source of nitrate and/or sulfate; and
(iv) admixing the material obtained in step (iii) with urea.

2. A method according to claim 1 wherein the digestate material comprises a digestate cake from anaerobic digestion of a waste product.

3. A method according to claim 1 wherein the composition comprising carbon dioxide is a gaseous composition.

4. A method according to claim 3 wherein the composition comprising carbon dioxide comprises biogas or the exhaust gas from combustion.

5. A method according to claim 1 wherein step (iii) involves contacting the material obtained in step (ii) with a source of nitrate ions.

6. A method according to claim 5 wherein the source of nitrate ions comprises calcium nitrate.

7. A method according to claim 1 wherein step (iii) involves contacting the material obtained in step (ii) with a source sulfate ions.

8. A method according to claim 7 wherein the source of sulfate ions comprises calcium sulfate.

9. A method according to claim 1 wherein step (iii) involves contacting the material obtained in step (ii) a source of potassium.

10. A method according to claim 1 wherein step (iii) involves contacting the material obtained in step (ii) with a source of phosphorous.

11. A method according to claim 1 wherein step (iv) involves contacting the material obtained in step (iii) with neat urea in solid form.

12. A method according to claim 1 wherein step (v) involves drying and/or pelletising the material obtained in step (iv).

13. A fertiliser composition obtained by the method of claim 1.

14. A method of increasing the nutrient content of a plant growing medium, the method comprising:
(i) providing a digestate material;
(ii) contacting the digestate material with a composition comprising carbon dioxide;
(iii) contacting the material obtained in step (ii) with a source of nitrate and/or sulfate;
(iv) admixing the material obtained in step (iii) with urea;
(v) optionally adding one or more further components and/or further processing the material obtained in step (iv); and
(vi) admixing the mixture obtained after step (iv) with the plant growing medium.
